(19) United States
(12) Patent Application Publication
(10) Pub. No.: US 2008/0257183 A1
(43) Pub. Date: Oct. 23, 2008

(54) TURN BAR ASSEMBLY FOR ROTARY PRESS

(75) Inventor: Tetsuya YAMAGUCHI, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOKYO KIKAI SEISAKUSHO, TOKYO (JP)

(21) Appl. No.: 12/061,844

(22) Filed: Apr. 3, 2008

(30) Foreign Application Priority Data
Apr. 18, 2007 (JP) 2007-109229

(51) Int. Cl. B41F 13/06

(52) U.S. Cl. 101/228

(57) ABSTRACT

Each of two split webs W1 and W2 (W1′ and W2′) bisected at a slitter 61 from a web W (W′) is allowed to travel into a former S1, S2 after it is adjusted widthwise in position.

To this end, an assembly is provided which comprises a first turn bar unit 1 comprising an entrance turn bar 11 for guiding one of the split webs so as to turn the direction in which the one split web travels at an angle of 90°, a guide roller 12 for turning the direction in which the one split web past the entrance turn bar travels at an angle of 180° and an exit turn bar 13 for guiding the one split web past the guide roller so as to turn the direction in which it travels at an angle of 90°; and a second turn bar unit 2 comprising an entrance turn bar 21 for guiding the other split web so as to turn the direction in which the other split web travels at an angle of 90°, a guide roller 22 for turning the direction in which the other split web past the first entrance turn bar travels at an angle of 180° and an exit turn bar 23 24 for guiding the other split web past the guide roller so as to turn the direction in which it travels at an angle of 90°, wherein the exit turn bars in both the turn bar units are movable widthwise of a said split web fed out thereof.

### TECHNICAL FIELD

The present invention relates to a turn bar assembly or apparatus in a rotary press in which a web supplied is split by a slitter into two split webs and in particular to a turn bar assembly or apparatus in such a rotary press that responds to and manages a change in width of such a split web that occurs as a result of alteration in width of a web supplied.

### BACKGROUND ART

In a rotary press in which a web supplied is split along a direction of its travel by a slitter into two split webs and such a split web is folded along a direction of its travel by a former, if the web prior to splitting is altered in width from a standard web, each split web comes to be varied in width from a standard split web, too, so that its width center is deviated from a center of the former.

In aligning the width center of a split web with that of a former, it has been the conventional practice either to transversely move the former relative to the split web or to dispose a turn bar unit between the slitter and the former such as to move each split web in a direction of its width to fit the split web in position to the former.

Referring to FIGS. 9 to 11, mention is first made of Prior Art 1 as a conventional makeup in which when the split web is altered in width, the former is changed in position in a direction of width of the web (see JP P 2004-338,814). In the Figures, character W designates a standard-in-width web of full width, W′ designates a narrow-in-width web of full width, W1 and W2 and W1′ and W2′ designate their respective split webs.

FIG. 9 is a plan view illustrating a rotary press having two printing sections P arranged therein. In this rotary press, a web W (W′) each printed in and each fed from a printing section P, P may be split or bisected by a slitter 61 into split webs W1 and W2 (W1′ and W2′) Such split webs W1 and W2 (W1′ and W2′) and the web W (W′) are guided selectively into a single web feed path (single web stream) in which the split webs W1 and W2 (W1′ and W2′) are laid one on the other and fed to one former S1 and into a double web feed path (double web stream) in which the two split webs W1 and W2 (W1′ and W2′) are fed to two formers S1 and S2, respectively.

In the single web feed path, one split web W2 (W2′) is passed over two half-width turn bars 62 and 63 having their axes angled at 45° to the direction of travel of the web W and oriented parallel to a plane of the traveling web W and thereby is moved to take a same position as the other split web W1 (W1′), and then is guided over a plurality of guide rollers to travel straight and laid on the other split web W1 (W1′) for feeding into the one former S1.

In the double web feed path; the web W (W′) is fed to travel via the guide rollers and split by a slitter 66 on a drag roller 65 positioned upstream of the formers S1 and S2 into the split webs W1 and W2 (W1′ and W2′) which are fed into the formers S1 and S2, respectively.

The two formers S1 and S2 in this Prior Art 1 are designed in an identical makeup and each mounted, as shown in FIG. 11, to a former rest 69 which is attached to a former carriage 70 along with forming rollers 67 and nipping rollers 68 so that when the former carriage 70 is moved by a former carriage drive (not shown), each former S1, S2 can be moved in a direction of width of the web according to a width of the web as shown in FIG. 10.

In FIG. 10, the state shown by solid lines indicates a state of the formers S1 and S2 in which the web width is a standard width, and the state shown by chain lines indicates a state of the formers S1 and S2 in which the web width is narrow, i. e. a nonstandard width. If the web width is narrow, the formers S1 and S2 are moved in the directions in which they are brought close to each other. Since portions of the formers S1 and S2 which are adjacent to each other then interfere with each other, blocks 71 and 71 are removably attached to these portions and when they are moved in their approaching directions, the blocks 71 and 71 are removed or replaced with ones that fit to the particular web width.

Referring to FIG. 12, mention is next made of Prior Art 2 as a conventional makeup in which a turn bar is moved to move a split web widthwise so as to fit it to the position of a former when the split web is altered in width (see JP P 2004-338,814 A).

FIG. 12 shows a rotary press in which a folder F is disposed in a direction perpendicular to the direction of travel of a web W fed out of a printing section P, P. In this rotary press, a web W fed out after printing in the printing section P or P is split by the slitter 61 into two split webs W1 and W2 Then, in one of double web feed paths, one split web W1 is passed over a half-width turn bar 73 whose axis is oriented at an angle of 45° to the direction of travel of the web W1 and parallel to a plane of the traveling web W1 and the other split web W2 is passed over a half-width turn bar 72 whose axis is oriented at an angle of 45° to the direction of travel of the web W2 and parallel to a plane of the traveling web W2 so that the split webs W1 and W2 are each turned in its direction of travel at an angle of 90° with their traveling planes before and after turning being parallel to each other and thereafter are fed into formers S1 and S2, respectively.

In the other double web feed path, the web W is passed over a full-width turn bar 74 whose axis is oriented at an angle of 45° to the direction of travel of the web W and parallel to a plane of the traveling web W so that the web W is turned in its direction of travel at an angle of 90° with its traveling planes before and after turning being parallel to each other and then is split by the slitter 66 on the drag roller 65 positioned in the folder into two split webs W1 and W2 which after that are fed into the formers S1 and S2, respectively.

In a single web feed path, the two half-width turn bars 72 and 73 are adjusted in position so that the two split webs W1 and W2 past these half-width turn bars are identical in their widthwise position to each other and then, laid one over the other, the split webs W1 and W2 are fed to one former S1 or S2.

When the web width has been altered, the half-width turn bars 72 and 73 and the full-width turn bar 74 are displaced in a direction parallel to the direction of travel of each web W1, W2, W fed to them so that the split webs W1 and W2 in their width centers or center are aligned with those or that of the former S1 and/or former S2, respectively.

Mention is next made of Prior Art 3 as a conventional makeup in which a turn bar is moved to change the widthwise position of a web (see JP P 2000-153,940 A).

The Prior Art 3 is as shown in FIG. 13, and it comprises a first turn bar 75 for turning a traveling web W at an angle of 90° while maintaining planes of the web W before and after the turning parallel to each other, a first guide roller 77 for turning at an angle of 180° the web W fed out of the first turn bar 75, a second guide roller 78 for turning at an angle of 180° the web W fed out of the first guide roller 77, a second turn bar 76 for turning at an angle of 90° the web fed out of the second guide roller 78 to cause the web W to travel downstream in the same direction of travel as that in which the web W enters the first turn bar 75, and a turn bar drive unit 79 for moving, together with the second guide roller 78, the second or downstream turn bar 76 widthwise of the web W traveling downwards from the second turn bar 76. Thus, moving the second turn bar 76 with the turn bar drive unit 79 causes the widthwise position of the web W fed out of the second turn bar 76 to move from the widthwise position of the web W entering the first turn bar 75.

Mention is next made of Prior Art 4 as a conventional makeup in which each of split webs W1 and W2 split from a web is moved widthwise by moving a turn bar (see JP P 2004-106,516 A).

This Prior Art 4 is as shown in FIGS. 14 and 15 and it comprises a slitter 90 for splitting the web into two, a first turn bar 80, 81 disposed in a path of each split web W1, W2 and a second turn bar unit 82, 83 disposed directly downstream thereof.

In the second turn bar unit 82, 83, a second turn bar 84, 85 and a guide roller 86, 87 are attached to a bracket 88, 89. And, the second turn bar unit 82, 83 as shown in FIG. 15 is made movable obliquely up and down along a linear guide member (not shown) relative to the first turn bar 80, 81.

The first turn bars 80 and 81 and the second turn bars 84 and 85 are in each pair oriented obliquely symmetrically with respect to the direction of travel of the web W and configured with respect to the latter in a V form with its apex at the point of splitting the traveling web W.

The web W traveling via a guide roller 91 is split by the slitter 91 from where the one split web W1 is fed out via the first turn bar 80 and the second turn bar 84 to the guide roller 86 and then fed out via a downstream guide roller 92 to a former S1 and the other split web W2 is fed out via the first turn bar 81 and the second turn bar 85 to the guide roller 87 and then fed out via the downstream guide roller 92 to a former S2.

And, when the web width is altered, the split webs W1 and W2 split from the web W at the slitter 90 are each shifted with the second turn bar unit 82, 83 moved up or down along the linear guide member relative to the fixed first turn bar 80, 81 to change the length of web traveling path between the first turn bar 80, 81 and the second turn bar 84, 85 and thereby to change the widthwise position of each split web W1, W2 so as to align the width center of each split web W1, W2 with the center of each former S1, S2.

In late years, an identical rotary press has been in demand, which can be adapted for webs that have a variety of web widths and are largely different in web width and which permits two split webs split by a slitter from a web to be fed to their respective formers as desired.

Prior Art 1 shown in FIGS. 9 to 11 has been so designed that, when the web width is altered, the formers S1 and S2 are moved and brought close to each other as the web width is smaller and are moved and brought away from each other in their opposed direction as the web width is larger. And, each of the formers S1 and S2 has been moved by the former carriage 70 having the former rest 67, the forming roller 67 and nipping roller 68 mounted therein in a unit with the former carriage drive unit (not shown).

Thus, if a large alternation of web width is desired, the former carriage drive must be large r in size and more complex than the conventional to be capable of moving the former carriage 70, 70 more largely in length. Also, for each web-width alternation, complex and time-consuming operations must become necessary, including an operation prior to printing to remove the block 71, 71 attached to the adjoining portions of the two formers S1 and S2 or to replace the block with the one suited for a new web size and operation thereafter to move the centers of the two formers S1 and S2 or one of the centers to positions or a position aligned respectively with the width centers or center of the web W1 and/or web W2.

Also, it is necessary to be prepared to leave the blocks 71, 71 fit to the web widths in numbers of web widths to be used. Further, there is the problem that if the two split webs W1 and W2 are laid together not at one former S1 in the single web feed path as shown and mentioned above, but at the other former S2 in the other single web feed path, it is necessary to reorient the half-width turn bars 62 and 63 at an angle of 90° from the state shown in FIG. 9 or to provide a separate plurality of turn bars reoriented at an angle of 90° so that one split web W1 may pass first over the half-width turn bar 63 and then over the half-width turn bar 62 and thereafter fit in widthwise position with the other slit web W2, and consequently it entails a time-consuming operation or requires a large number of turn bars to switch the web width

Prior Art 2 as shown in FIG. 12 involves the problem that it requires a space for its installation larger than the space for the prior one-row rotary-press arrangement shown in FIG. 9 since a folder is arranged in a direction perpendicular to the path of travel of a web W fed out of the printing section P, this problem becoming noticeable if more than two row of rotary press are arranged.

Prior Art 3 as shown in FIG. 13 is to vary the web widthwise position for one web W alone and does not respond to or manage changing the respective widthwise positions of split webs split from one web W.

Prior Art 4 as shown in FIG. 14 has the problem that while it changes the widthwise positions of split webs W1 and W2 split by a slitter 90 from one web to align the width centers of the traveling split webs W1 and W2 with the centers of formers S1 and S2, the apparatus is incapable of providing the so-called single web feed path in which split webs W1 and W2 traveling parallel are laid one over the other and then fed to one former S1 or S2.

In view of the foregoing, it is an object to provide a turn bar assembly in rotary press which is simple and does not require complicate operations for parts replacements, which can respond to and manage alteration of a variety web widths which may largely vary, which is capable of feeding each of split webs into a desired one of formers, which can quickly switch between the one-web and double web feed paths, and further which has a reduced space for installation with printing sections and a folder arranged in a row.

### DISCLOSURE OF THE INVENTION

In order to achieve the object mentioned above, there is provided in accordance with the present invention a turn bar assembly in a rotary press in which a web fed from a web supply and printed in a printing section is split by a slitter into two split webs, the assembly comprising: a first turn bar unit comprising a first entrance turn bar for guiding one of the split webs so as to turn the direction in which the one split web travels at an angle of 90° while maintaining parallel planes of the one split web before and after its direction of travel is turned by the first entrance turn bar, a first guide roller for turning the direction in which the one split web past the first entrance turn bar travels at an angle of 180° and a first exit turn bar for guiding the one split web past the first guide roller so as to turn the direction in which it travels at an angle of 90° while maintaining parallel planes of the one split web past the first guide roller before and after its direction of travel is turned by the first exit turn bar; and a second turn bar unit comprising a second entrance turn bar for guiding the other of the split webs so as to turn the direction in which the other split web travels at an angle of 90° while maintaining parallel planes of the other split web before and after its direction of travel is turned by the second entrance turn bar, a second guide roller for turning the direction in which the other split web past the second entrance turn bar travels at an angle of 180° and a second exit turn bar for guiding the other split web past the second guide roller so as to turn the direction in which it travels at an angle of 90° while maintaining parallel planes of the other split web past the second guide roller before and after its direction of travel is turned by the second exit turn bar, wherein the first and second exit turn bars are movable widthwise of a said split web fed out thereof.

According to the turn bar assembly in a rotary press of the present invention in which a web fed from each of printing sections is bisected into a pair of split webs, each of split webs, when each such split web is provided with a turn bar unit including an exit turn bar whose position widthwise of each split web is adjusted, can be fed into a former positioned downstream in direction of its travel of each such turn bar unit with its widthwise center aligned with a center of the former.

And, the turn bar assembly is simple in makeup, does not require any complicate operation such as a part replacement, and can respond to and manage web width alterations from a variety of web widths which may vary largely. Moreover, each split web can be fed out into a former as desired. And, allowing the printing sections and the folder to be arranged in a row, the assembly is prevented from space increase for its installation and can easily be fitted to an existing rotary press machine.

Further, in the turn bar assembly provided herein, the second turn bar unit may include a pair of such second exit turn bars whereby the split web fed out of the second turn bar unit is capable of selectively traveling at one of two widthwise positions.

According to this specific makeup, providing two exit turn bars in the turn bar unit processing the other split web allows quickly switching between a single web feed path or mode in which the other split web is laid above or below the one split web and a double web feed path or mode in which the two split webs are placed by side by side.

### BRIEF DESCRIPTION OF THE DRAWINGS

In the Drawings:

FIG. 1 is a front view diagrammatically illustrating a turn bar assembly in rotary press as a form of implementation of the present invention;

FIG. 2 is a front view enlarged of a part of the turn bar assembly shown in FIG. 1;

FIG. 3 is a plan view taken along the line III-III as seen from the direction of the arrow in FIG. 2, diagrammatically illustrating an entrance turn bar section and a guide roller section in a first turn bar unit;

FIG. 4 is a plan view taken along the line IV-IV as seen from the direction of the arrow in FIG. 2, diagrammatically illustrating the guide roller section, an exit turn bar section and a secondary guide roller section in the first turn bar unit and formers;

FIG. 5 is a plan view taken along the line V-V as seen from the direction of the arrow in FIG. 2, diagrammatically illustrating an entrance turn bar section and a guide roller section in a second turn bar unit;

FIG. 6 is a plan view taken along the line VI-VI as seen from the direction of the arrow in FIG. 2, diagrammatically illustrating the guide roller section, an exit turn bar section and a secondary guide roller section in the second turn bar unit and the formers;

FIG. 7 is a plan view diagrammatically illustrating a guide roller and an exit turn bar section which are modified in the first turn bar unit shown in FIG. 4 and the formers;

FIG. 8 is a plan view diagrammatically illustrating a guide roller and an exit turn bar section which are modified in the second turn bar unit shown in FIG. 6 and the formers;

FIG. 9 is a plan view diagrammatically illustrating Prior Art 1 designed to move a former section widthwise;

FIG. 10 is a front view diagrammatically illustrating the former section in Prior Art 1:

FIG. 11 is a side view of the former section shown in FIG. 10;

FIG. 12 is a plan view diagrammatically illustrating Prior Art 2;

FIG. 13 is a plan view diagrammatically illustrating Prior Art 3;

FIG. 14 is a plan view diagrammatically illustrating Prior Art 4; and

FIG. 15 is a side view diagrammatically illustrating Prior Art 4.

### BEST MODES FOR CARRYING OUT THE INVENTION

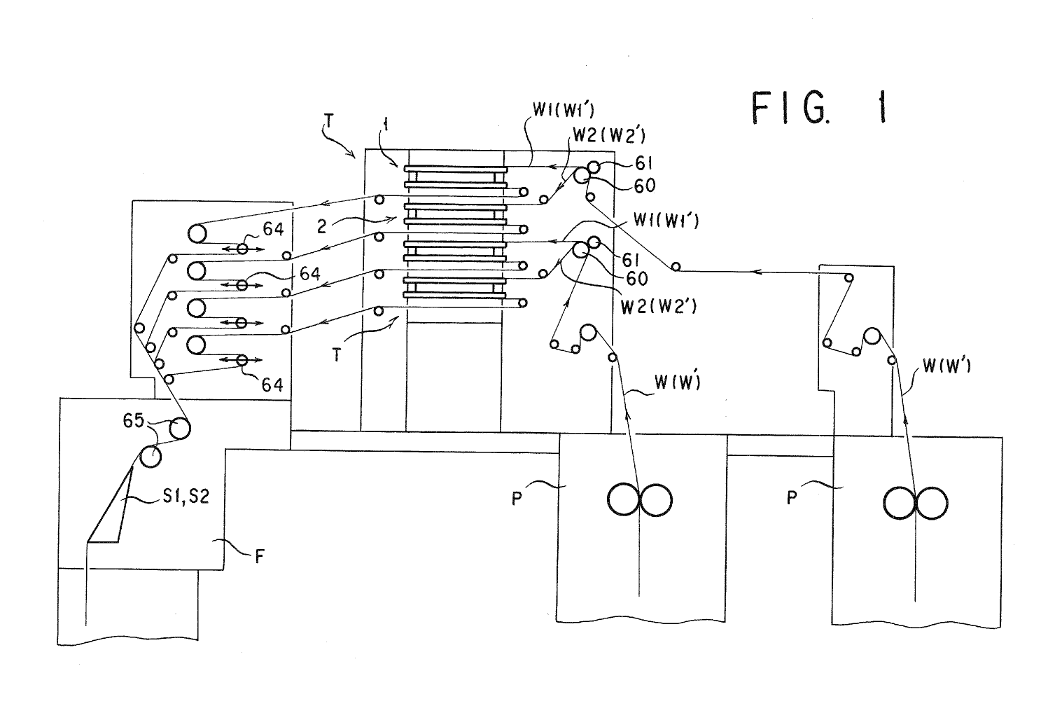

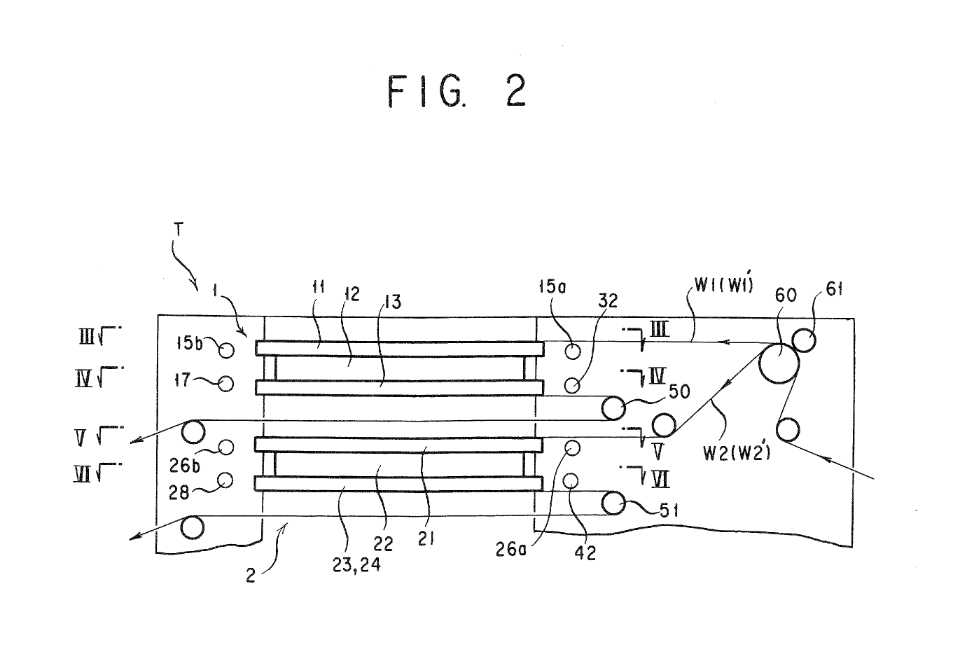

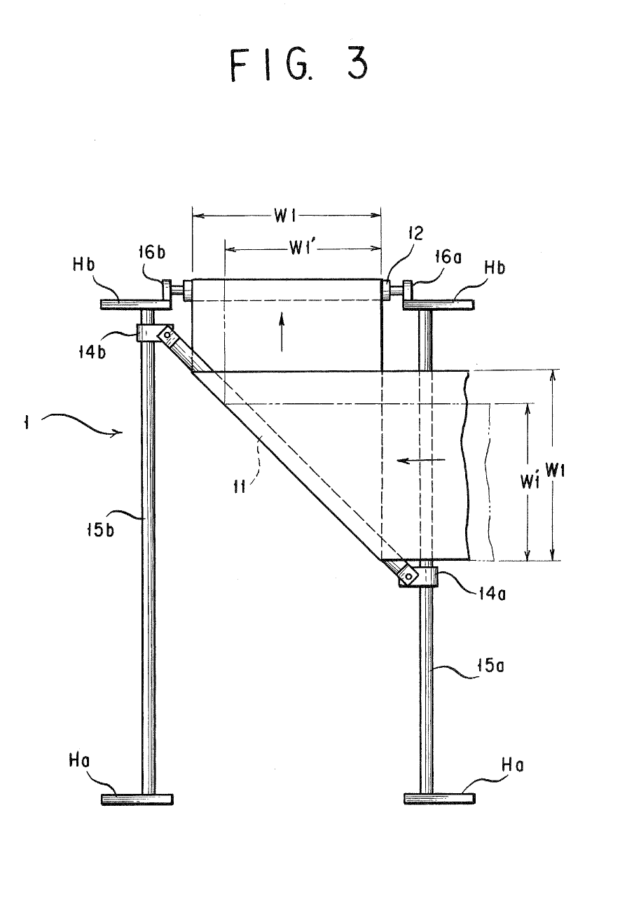

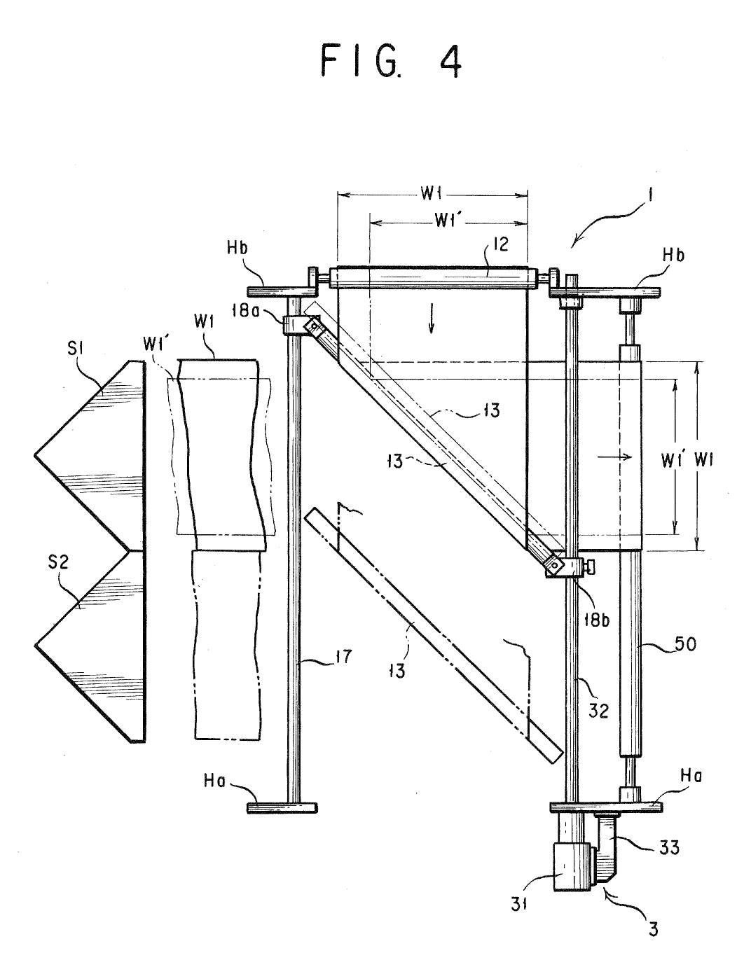

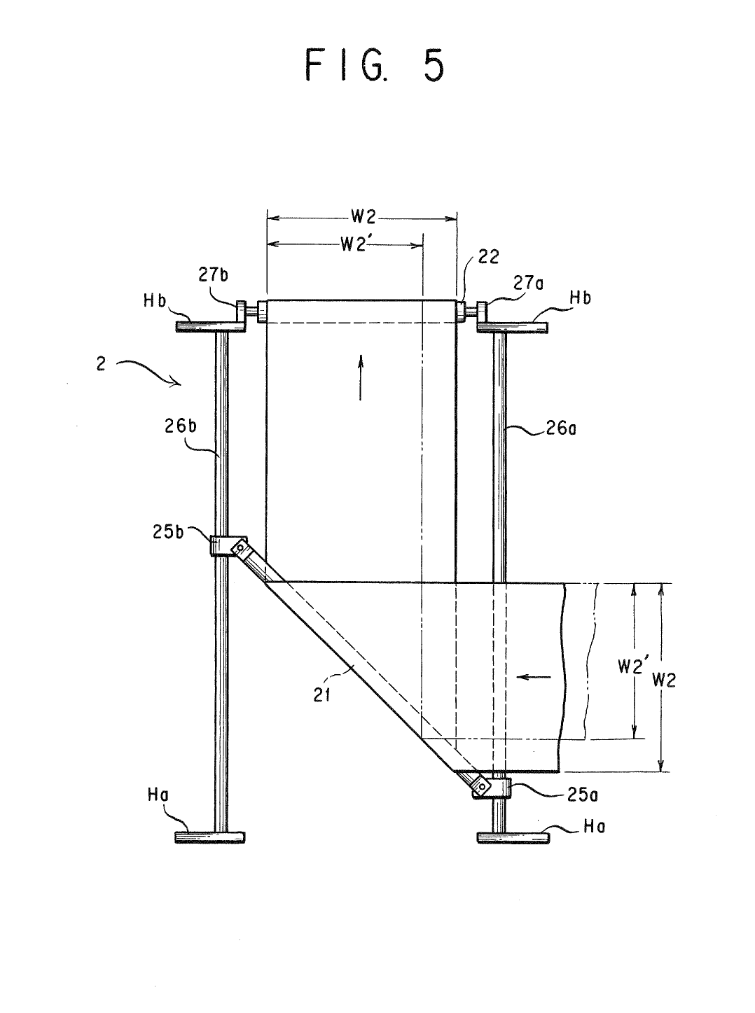

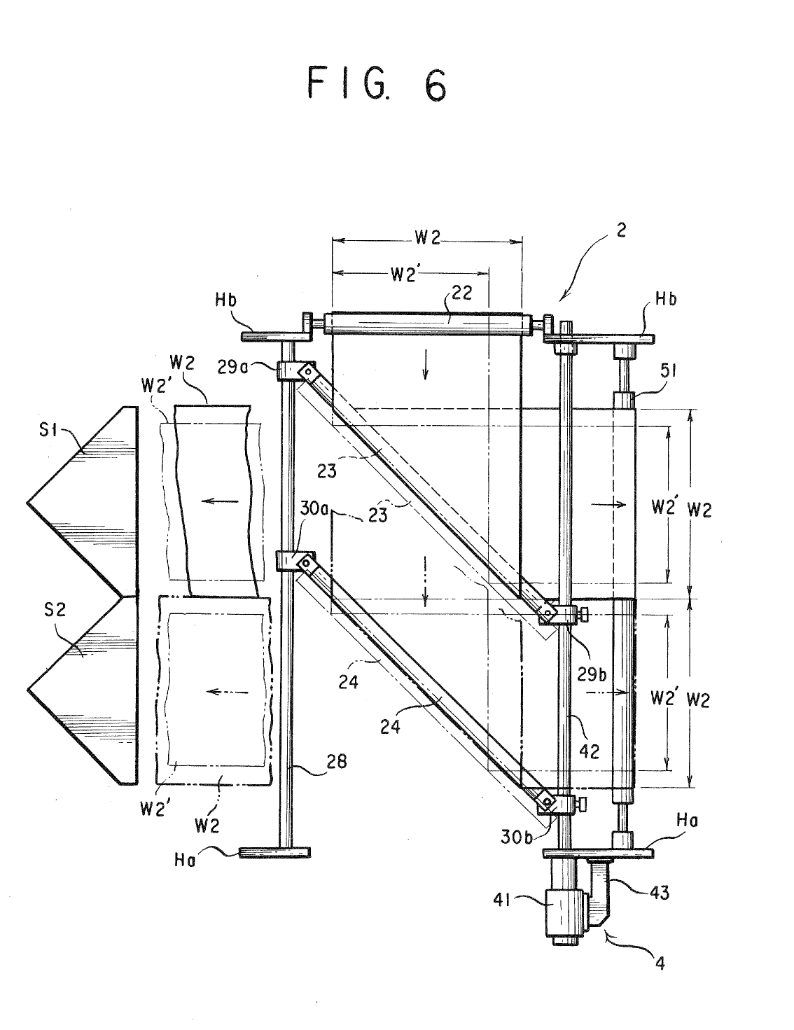

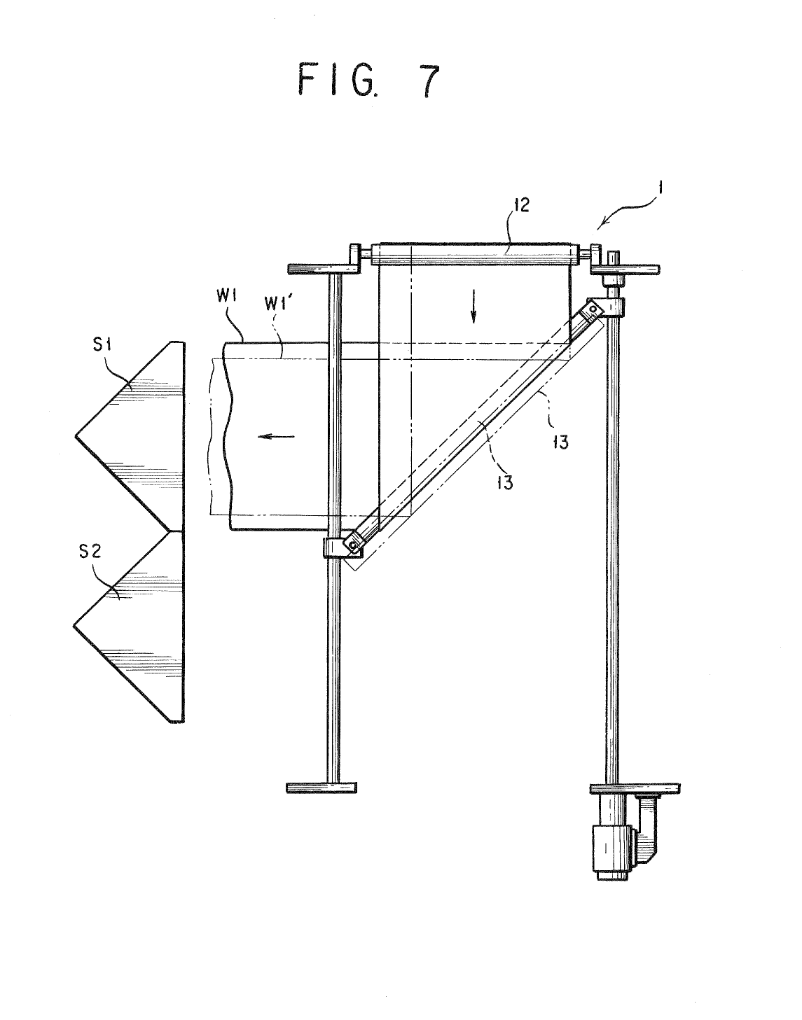

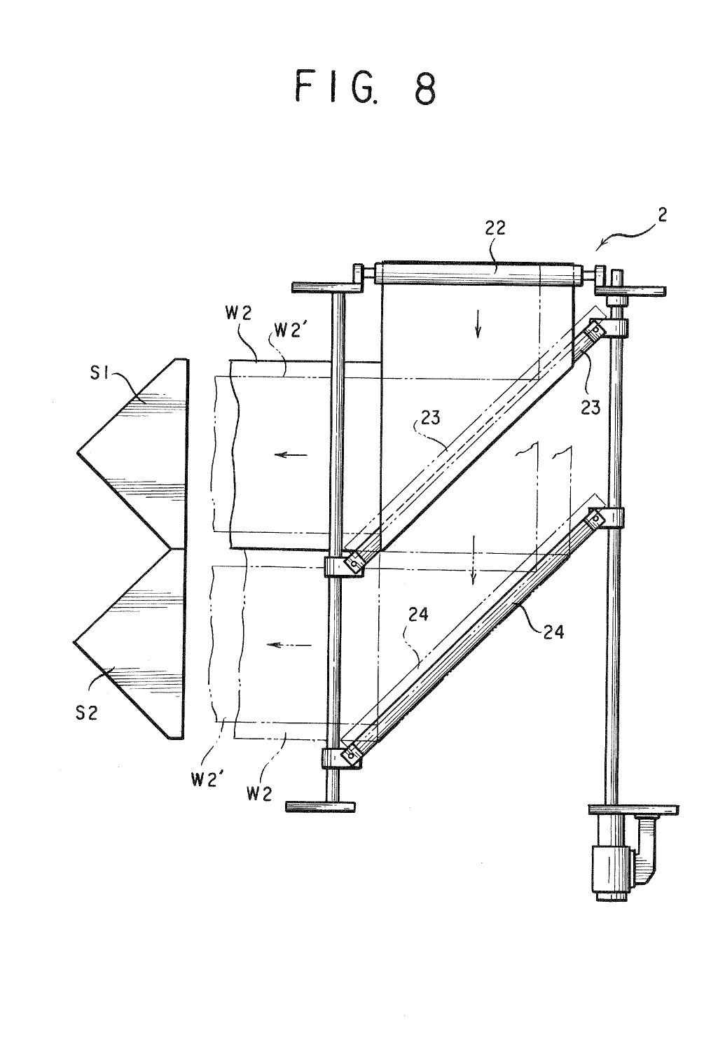

Referring to FIGS. 1 to 8, a form of implementation of the present invention is described. FIG. 1 is a front view illustrating a turn bar assembly in a rotary press; FIG. 2 is a front view illustrating this turn bar assembly as enlarged; FIG. 3 is a plan view taken along the line III-III as seen from the direction of the arrow in FIG. 2; FIG. 4 is a plan view taken along the line IV-IV as seen from the direction of the arrow in FIG. 2; FIG. 5 is a plan view taken along the line V-V as seen from the direction of the arrow in FIG. 2; FIG. 6 is a plan view taken along the line VI-VI as seen from the direction of the arrow in FIG. 2; and FIGS. 7 and 8 are plan views illustrating modifications of exit turn bars.

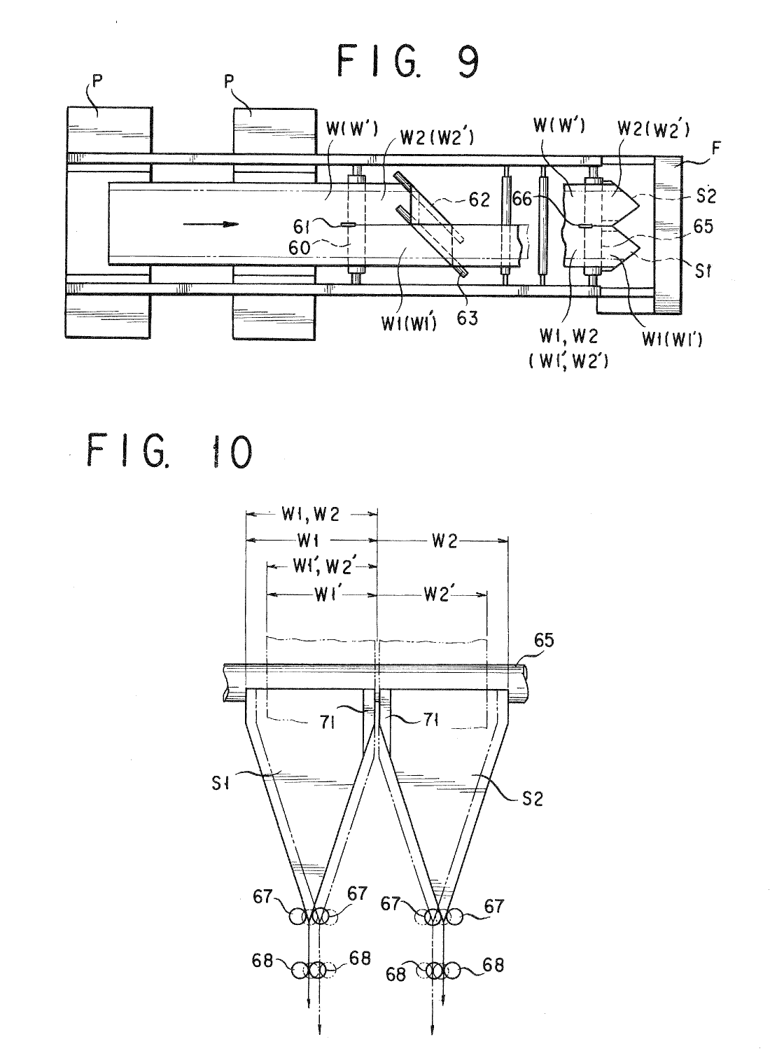

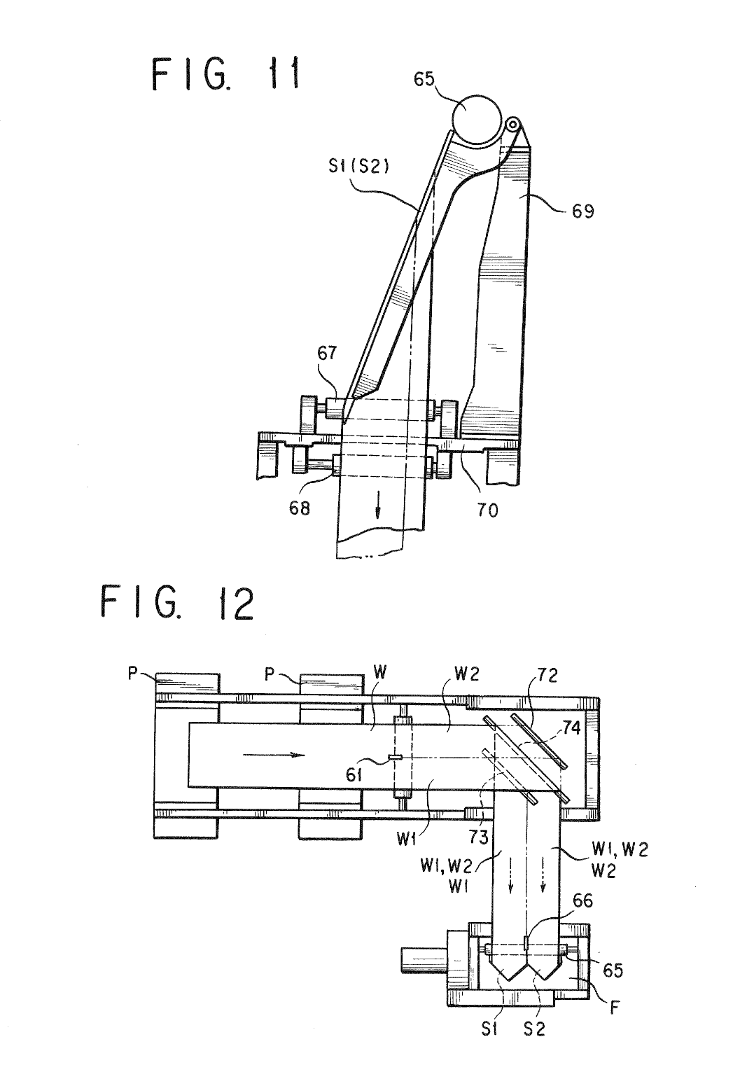

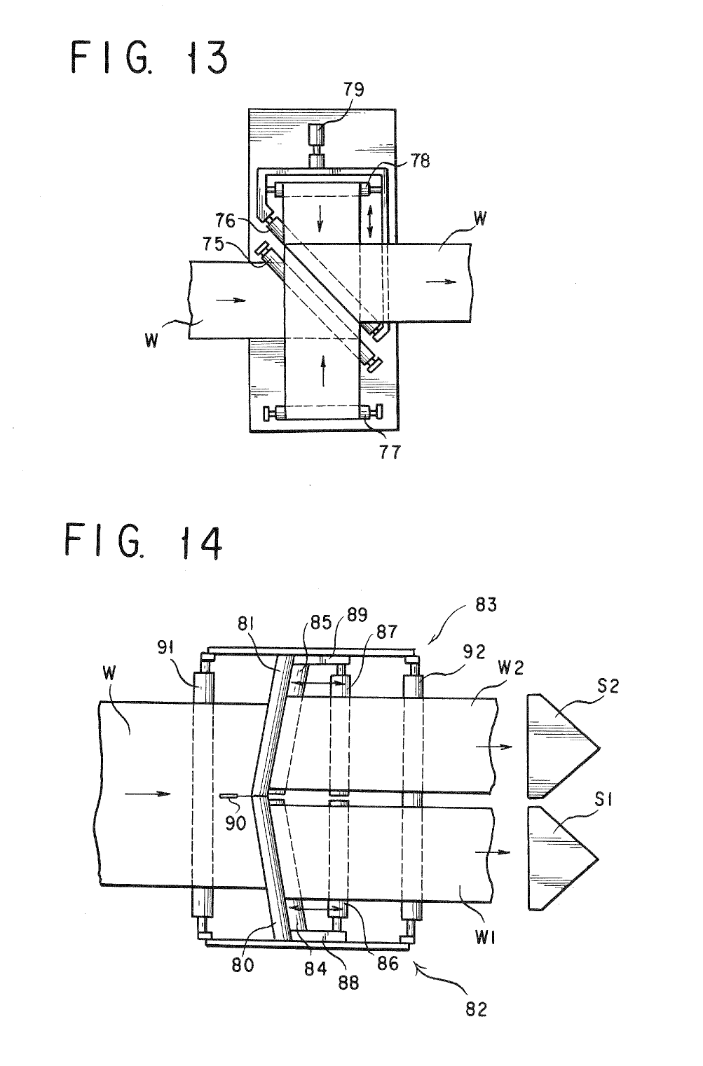

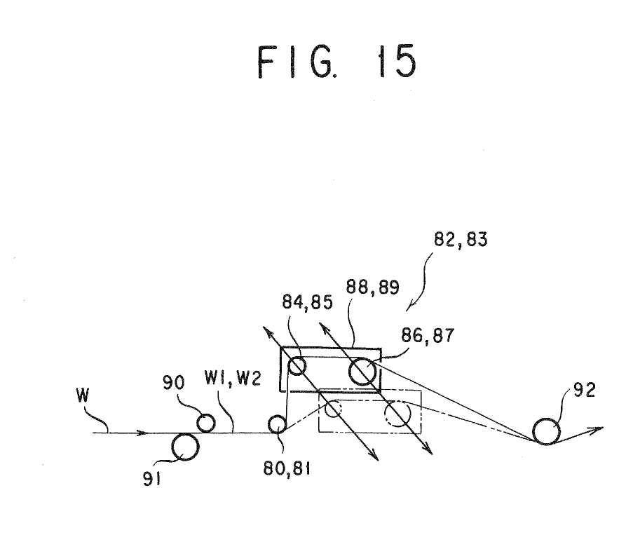

In FIGS. 1 to 8 showing forms of implementation of the invention as in FIGS. 9 to 11 showing Prior Art 1, a web that is broader in width and of standard width is shown in solid lines and designated by reference character W and a web that is narrower in width and of nonstandard width is shown in chain lines and designated by W′. Split webs split from a webs W and W′ are designated by W1, W2 and W1′, W2′, respectively, where a narrower split web is indicated by attaching inverted comma (′) to W1, W2.

The description that follows is conveniently given with reference to a broader web W and split webs W1 and W2 bisected therefrom from.

In FIG. 1, a plurality of printing sections P, P, e. g. two in this form of implementation, are shown each for printing a web W of full width in a rotary press. And, the web W printed at each printing section P is shown split by a drag roller 60 and a slitter 61 into two split webs W1 and W2. Turn bar assemblys T, T are each disposed down stream of the drag roller 60 and splitter 61 for each splitting. These turn bar assemblys T and T are provided for the webs from the printing sections P and P, respectively, and provided deviated in position from each other vertically up and down. Since these turn bar assemblys T and T deviated in position from each other vertically up and down are identical in makeup, the description that follows is given of the turn bar assembly T positioned uppermost.

The turn bar assembly T comprises a first turn bar unit 1 whereby one split web W1 split at the slitter 61 from the web W is adjusted as to its traveling position at its exit side relative to that at its entrance side in its widthwise direction and a second turn bar unit 2 whereby the other split web W2 is adjusted as to its traveling position at its exit side relative to that at its entrance side in its widthwise direction. These two turn bar units 1 and 2 are provided deviated in position vertically as shown in FIGS. 1 and 2 and provided at an identical position as to the direction of travel of the web W. And, downstream in traveling direction of the respective exit sides of the two turn bar units 1 and 2 there are arranged formers S1 and S2 which longitudinally fold the split webs W1 and W2, respectively. Reference character 64 indicates an adjusting roller.

The first turn bar unit 1 as shown in FIG. 2 comprises an entrance turn bar 11, a guide roller 12 and an exit turn bar 13 which are deviated in position vertically and shown in order from top. And in this form of implementation the first turn bar unit 1 is provided below the exit turn bar 13 with a secondary guide roller 50.

In the first turn bar unit 1 as shown in FIGS. 3 and 4, the entrance turn bar 11 has its axis inclined at an angle of 450 to the direction of travel of the split web W1 and disposed parallel to a plane of the traveling web W1. The entrance turn bar 11 has blocks 14a and 14b attached to its opposite ends, respectively, and the blocks 14a and 14b are fastened to shafts 15a and 15b whose respective first and second ends are fastened to frames Ha and Hb, respectively.

The guide roller 12 has its axis extending parallel to the direction of travel of the split web W1 entering the entrance turn bar 11 and is disposed laterally of the entrance turn bar 11. The guide roller 12 at its opposite ends is rotatably mounted between brackets 16a and 16b fastened to the frame Hb, Hb.

The exit turn bar 13 in this form of implementation is disposed parallel to the entrance turn bar 11 and has its one end attached to a block 18a slidably mounted on a shaft 17 whose opposite ends are fastened to the frames Ha and Hb, respectively. The exit turn bar 13 has its other end attached to a block 18b which is slidably mounted on, but can be securely fastened by a known suitable fixing means such as a set screw to, a shaft 32 of a first drive unit 3 for exit turn bar to be described later

The secondary guide roller 50 has its axis extending orthogonal to the direction of travel of the split web W1 entering the entrance turn bar 11 and parallel to the plane of the traveling split web W1. The secondary guide roller 50 is disposed behind the exit turn bar 13 and has its opposite ends rotatably mounted between the frames Ha and Hb.

The second turn bar unit 2 as shown in FIG. 2 comprises an entrance turn bar 21, a guide roller 22 and a pair of exit turn bars 23 and 24 which are deviated in position vertically and shown in order from top. And in this form of implementation the second turn bar unit 2 is provided below the exit turn bars 23 and 24 with a secondary guide roller 51.

In the second turn bar unit 2 as shown in FIGS. 5 and 6, the entrance turn bar 21 has its axis inclined at an angle of 45° to the direction of travel of the split web W2 and disposed parallel to a plane of the traveling web W2. The entrance turn bar 21 has blocks 25a and 25b attached to its opposite ends, respectively, and the blocks 25a and 25b are fastened to shafts 26a and 26b whose respective first and second ends are fastened to frames Ha and Hb, respectively.

The guide roller 22 has its axis extending parallel to the direction of travel of the split web W2 entering the entrance turn bar 21 and is disposed laterally of the entrance turn bar 21. The guide roller 22 at its opposite ends is rotatably mounted between brackets 27a and 27b fastened to the frame Hb, Hb.

The two exit turn bars 23 and 24 in this form of implementation are disposed parallel to the entrance turn bar 21 and have their respective first ends attached to blocks 29a and 30a, respectively, which are each slidably mounted on a shaft 28 whose opposite ends are fastened to the frames Ha and Hb, respectively. The exit turn bars 23 and 24 have their second ends attached to blocks 29b and 30b, respectively, which are each slidably mounted on, but can be securely fastened by a known suitable fixing means such as a set screw to, a shaft 42 of a second drive unit 4 for exit turn bars which will be described later.

In the first drive unit 3 for exit turn bar, the shaft 32 for the block 18b attached to the other end of the exit turn bar 13 is mounted on the frame Ha, Hb as shown in FIG. 4 so that it is not rotated but movable in a direction parallel to the direction of travel of the split web W1 entering the exit turn bar 13. And, the shaft 32 is provided at its one end with a threaded portion (not shown) to which the output shaft of a motor 31 mounted to the frame Ha via a bracket 33 is axially thread-coupled so that rotating the motor 31 causes the shaft 32 to be axially moved by screw feeding via the thread-coupled part. With the shaft 32 so moved, the block 18b fastened to this shaft 32 is moved together therewith, thereby permitting the exit turn bar 13 to be adjusted in position in the direction of travel of the split web W1 entering the exit turn bar 13.

With the first drive unit 3 for exit turn bar where it is desired to largely move the exit turn bar 13 in the direction of travel of the split web W1 entering the exit turn bar 13 as shown in FIG. 4, the block 18b to which the other end of the exit turn bar 13 is attached may be released from the fixing means that fastens the block 18b to the shaft 32 and then he manually moved. And, the block 18b upon reaching a selected position may be fastened by the fixing means. Then, the exit turn bar 13 manually thus moved may be adjusted in position by a motor 31.

In the second drive unit 4 for exit turn bars, the shaft 42 for the blocks 29b and 30b attached to the second ends of the exit turn bars 23 and 24, respectively is mounted on the frame Ha, Hb as shown in FIG. 6 so that it is not rotated but movable in a direction parallel to the direction of travel of the split web W2 entering the exit turn bars 23 and 24 And, the shaft 42 is provided at its one end with a threaded portion (not shown) to which the output shaft of a motor 41 mounted to the frame Ha via a bracket 43 is axially thread-coupled so that rotating the motor 41 causes the shaft 42 to be axially moved by screw feeding via the thread-coupled part. With the shaft 42 so moved, the blocks 29b and 30b fastened to this shaft 42 is moved together therewith, thereby permitting the exit turn bars 23 and 24 to be adjusted in position in the direction of travel of the split web W2 entering the exit turn bars 23 and 24.

Mention is next made of the use of a web W of standard (broader) width in describing an operation of the turn bar assembly T in rotary press so constructed as mentioned above.

Prior to printing at printing sections P and P, a width size of the web W to be printed is entered to a controller (not shown). The motor 31 in the first turn bar unit 1 and the motor 41 in the second turn bar unit 2 are rotated by the controller to move their respective shafts 32 and 42 widthwise of the split webs W1 and W2 fed out of the exit turn bar 13 in the first turn bar unit 1 and the exit turn bar 23 or 24 in the second turn bar unit 2, respectively, so that the width centers or center of the split webs W1 and W2 fed out of the exit turn bars 13 and 23 or 24 are aligned with the centers or center of the one former S1 and/or the other former S2, respectively.

During a printing operation, the web fed from its supply (not shown) and printed in the printing sections P and P is split by the slitter 61 at the drag roller 60 into two split webs W1 and W2 of which one split web W1 travels into the first turn bar unit 1 as shown in FIG. 3 and the other split web W2 travels into the second turn bar unit 2 as shown in FIG. 5.

The one split web W1 traveling into the first turn bar unit 1 is turned in its direction of travel at an angle of 90° by the entrance turn bar 11 and then is fed to the guide roller 12 where it is turned in its direction of travel at an angle of 180° and then fed to the exit turn bar 13. By the exit turn bar 13 the split web W1 is turned again in its direction of travel at an angle of 90° and the width center of the split web W1 turned thereby is aligned with the center of one former S1. And, the split web W1 traveling out of this exit turn bar 13 is turned in its direction of travel by the secondary guide roller 50 towards its outlet side from which it is fed via the adjusting roller (64 into the one former S1.

The other split web W2 is turned in its direction of travel at an angle of 90° by the entrance turn bar 21 and then is fed to the guide roller 22 where it is turned in its direction of travel at an angle of 180° and then fed to the exit turn bar 23, 24. Then, the split web W2 if it is fed below the one split web W1 at the same widthwise position as the split web W1, namely if it is caused to travel in the single web feed path, is wound on the one exit turn bar 23 positioned closer to the inlet path of travel of the one split web W1. Also, the other split web W2 out of the guide roller 22 if it fed out side by side with the one split web W1, namely if it is caused to travel in the double web feed path, is wound on the other exit turn bar 24 positioned closer to the inlet path of travel of the one split web W2.

If the single web feed path is selected as indicated in solid lines for the web W2 in FIG. 6, the split web W2 fed out of the guide roller 22 is turned in its direction of travel at an angle of 90° by the one exit turn bar 23 and the width center of the split web W2 turned thereby is aligned with the center of one former S1. And, the split web W2 traveling out of this exit turn bar 23 is turned in its direction of travel at an angle of 180° by the secondary guide roller 51 towards its outlet side from which it is fed via the adjusting roller 64 into the one former S1 where to fold it with the one split web W1 laid thereon

If the double web feed path is selected as indicated in heavy chain lines for the web W2 in FIG. 6, the split web W2 fed out of the guide roller 22 is turned in its direction of travel at an angle of 90° by the other exit turn bar 24 and the width center of the split web W2 turned thereby is aligned with the center of one former S2. And, the split web W2 traveling out of this exit turn bar 24 is turned in its direction of travel at an angle of 180° by the secondary guide roller 51 towards its outlet side from which it is fed via the adjusting roller 64 into the other former S2 where it is folded out parallel to the one split web W1.

While the single web feed path was shown to use one former S1 side as one embodiment, it may use the other former S2 side as the alternative embodiment. To do this, as shown in the heavy chain lines in FIG. 4 the exit turn bar 13 in the first turn bar unit 1 is moved to a position where it is opposed to the other former S2 so that the split web W1 traveling from the guide roller 12 is fed out of the exit turn bar 13 at this position via the secondary guide roller 50 into the former S2. And, the other split web W2 is allowed to travel through a path passing through the exit turn bar 24 and may then be placed beneath the split web W1 at the former S2.

At this time, the exit turn bar 13 may be moved upon unfastening the fixing means that fastens the block 18b to the shaft 32 and then by largely moving the block 18b. Thereafter, upon fastening the block 18b to the shaft 32 by the fixing means again, the position at a need may be adjusted with the motor 31.

Also as an alternative embodiment of the double web feed path, the exit turn bar 13 in the first turn bar unit 1 as shown in the heavy chain lines in FIG. 4 may be registered to position opposed to the other former S2 and the exit turn bar 23 in the second turn bar unit 2 shown in FIG. 6 may be used for the other split web W2 so as to feed the one split web W1 to the other former S2 and the other split web W2 to the one former S1.

Further, so that the widthwise ends of both the split webs W1 and W2 may meet at the former S1 or S2 with the ends of webs printed at another printing section or so that the respective widthwise ends of the split webs W1 and W2 (or W2 and W1) may meet at the formers S1 and S2 with the ends of webs printed at another printing section, a web end detector (not shown) and a controller (not shown) may be used to rotate the motor 31 and the motor 41 so as to finely adjust the web widthwise positions at the exit turn bar 13 and the exit turn bars 23 and 24. Also, with the adjusting roller 64, each lengthwise end position of images printed on split web W1 and/or W2 may be adjusted to meet with that of an image printed at another section.

Mention is next made of the use of a nonstandard web W′ of a width narrower than the standard width.

With the web W′ being split about a split line passing though its widthwise center by the slitter 61, its split webs are fed into the entrance turn bars 11 and 21 in the state they are deviated towards the split line in comparison with the split webs W1 and W2 of standard width, as shown in FIGS. 3 and 5. Since this deviation is the same in the way from the guide roller 12, 22 to the exit turn bar 13, 23, 24, if the, as they are, are fed out of the exit turn bar 13, 23, 24 via the secondary guide roller 50, 51 towards the exit end, they as they are deviated will then come to be fed into the former S1, S2 positioned with its center aligned with the widthwise center of a split web W1, W2 bisected from a web of standard width W.

Thus, each exit turn bar 13, 23, 24 is moved by the drive unit 3, 4 to a position as indicated in the chain line so that the split web W1′, W2′ centered identically to the split web W1, W2 of standard width may come out of the exit turn bar 13, 23, 24, as shown in FIGS. 4 and 6.

As a result, the split web W1′, W2′ of a width narrower than standard is fed out to a position aligned with the center position of each former S1, S2.

The forms of implementation described above may be modified without departing from the Claims.

For example, the exit turn bar 13, 23, 24 may be manually moved. Also, as shown in FIGS. 7 and 8, the exit turn bar 13, 23, 24 may be reoriented by an angle of 90° from the one shown in FIGS. 4 and 5 so that the split web W1, W2 (W1′, W2′) is directly fed out of the exit turn bar 13, 23, 24 into the former S1, S2.

Further, only one exit turn bar may be used in each of the first and second turn bar units 1 and 2 to permit this exit turn bar to be moved to a web widthwise position, thereby meeting with a demand for both one- and double web feed paths into a desired former Also, two exit turn bars in each of the first and second turn bar units 1 and 2 may selectively be used to meet with a demand for both one- and double web feed paths into a desired former.

What is claimed is:

1. A turn bar assembly in a rotary press in which a web fed from a web supply and printed in a printing section is split by a slitter into two split webs, the assembly comprising:
a first turn bar unit comprising a first entrance turn bar for guiding one of said split webs so as to turn the direction in which said one split web travels at an angle of 90° while maintaining parallel planes of said one split web before and after its direction of travel is turned by said first entrance turn bar, a first guide roller for turning the direction in which said one split web past said first entrance turn bar travels at an angle of 180° and a first exit turn bar for guiding said one split web past said first guide roller so as to turn the direction in which it travels at an angle of 90° while maintaining parallel planes of said one split web past said first guide roller before and after its direction of travel is turned by said first exit turn bar; and
a second turn bar unit comprising a second entrance turn bar for guiding the other of said split webs so as to turn the direction in which said other split web travels at an angle of 90° while maintaining parallel planes of said other split web before and after its direction of travel is turned by said second entrance turn bar, a second guide roller for turning the direction in which said other split web past said second entrance turn bar travels at an angle of 180° and a second exit turn bar for guiding said other split web past said second guide roller so as to turn the direction in which it travels at an angle of 90° while maintaining parallel planes of said other split web past said second guide roller before and after its direction of travel is turned by said second exit turn bar, wherein
said first and second exit turn bars are movable widthwise of a said split webs fed out thereof.

2. A turn bar assembly in rotary press as set forth in claim 1 wherein said second turn bar unit includes a pair of such second exit turn bars whereby the split web fed out of said second turn bar unit is capable of selectively traveling at one of two widthwise positions
